(19) United States
(12) Patent Application Publication
(10) Pub. No.: US 2025/0244468 A1
(43) Pub. Date: Jul. 31, 2025

(54) Detecting a Presence of a Tag Attached to a Battery within a Receptacle Received by a Vehicle

(71) Applicant: Bayshore Recycling Services LLC, Atlantic Highlands, NJ (US)

(72) Inventors: Daniel M. Dobkin, Sunnyvale, CA (US); Tali Freed, Atascadero, CA (US); Duncan Culver, Howell,, NJ (US)

(73) Assignee: Bayshore Recycling Services LLC, Atlantic Highlands, NJ (US)

(21) Appl. No.: 19/183,788

(22) Filed: Apr. 19, 2025

Related U.S. Application Data
(63) Continuation-in-part of application No. 18/930,674, filed on Oct. 29, 2024.
(60) Provisional application No. 63/629,495, filed on Oct. 30, 2023.

(51) Int. Cl. G01S 13/75; B65F 3/02

(52) U.S. Cl. CPC G01S 13/751; B65F 3/02; B65F 2003/023

(57) ABSTRACT

Apparatuses, methods, and systems for detecting the presence of a beacon are disclosed. An embodiment includes a vehicle that includes a load arm configured to receive a receptacle, a first detector oriented relative to the load arm to receive a first wireless signal when the load arm is in a first position, a second detector oriented relative to the load arm to receive a second wireless signal when the load arm is in a second position, and a controller configured to detect presence of a tag attached to a specific object within the receptacle based on the received signal strengths of the first wireless signal and the second wireless signal.

### RELATED PATENT APPLICATIONS

This patent application is a continuation-in-part (CIP) of U.S. Non-provisional patent application Ser. No. 18/930,674 filed Oct. 29, 2024, which claims priority to Provisional Patent Application Ser. No. 63/629,495 filed Oct. 30, 2023, which are herein incorporated by reference.

### FIELD OF THE DESCRIBED EMBODIMENTS

The embodiments described relate generally to detection of batteries. More particularly, the embodiments described relate to systems, methods, and apparatuses for detecting the presence of a tag attached to a battery within a receptacle received by a vehicle.

### BACKGROUND

The use of lithium ion batteries of varying chemistries is extensive and rapidly expanding, due to their high energy density per unit mass, good charging behavior, and long endurance. Because the lithium reacts readily with water, and battery operating voltage exceeds the ionization threshold of water, aqueous electrolytes cannot be used. As a consequence, most lithium ion batteries employ flammable organic compounds in their electrolytes. Any stress or mechanical damage that causes a localized short circuit and release of electrical energy may induce combustion of the electrolyte. Ignition may also result from thermal runaway, due to complex reactions taking place within the battery. If other flammable materials are in the vicinity of the battery at this time, a fire may result. Batteries may remain flammable long after the last normal charging operation.

The increasing employment of such batteries results in increasing numbers of lithium ion batteries in waste and general recycling streams, disposed of individually or still incorporated in cellular phones, laptop computers, or other battery-powered hardware. Recycling collectors typically employ trucks to collect recycling material from bins or dumpsters. The trucks then supply the materials to a sorting and processing facility. Lithium batteries can ignite due to thermal runaway or mechanical damage when within a truck, representing a potential danger to the driver and surrounding people and property. Even when it is sufficient to dump the truck contents and manually remove and extinguish the flammable materials, considerable time and cost are incurred, and such fires always present a risk of damage to the truck and surroundings, and a danger to the driver and nearby people. Particularly in the case where a single recycling stream must be processed, recycling processors must rapidly sort large amounts of solid materials delivered by large trucks of varying configuration. FIG. 1 shows a delivery truck 106 that dumps a recycling stream 108 on a tipping floor 100, and the delivered recycling stream 104 is transferred by a front loader 102 to conveyorized transport and sorting operations, according to the prior art. The approach of FIG. 1 includes dumping the recycling stream from each truck onto a large flat tipping floor 100, often in an enclosed area. The stream materials (previously delivered recycling stream 104) are then picked up by a front-end loader 102 or other handling equipment, and transferred to conveyorized handling streams for processing and separation. The supply trucks and loaders are both heavy vehicles with hard wheels, and can easily damage batteries during handling. Fires can result from this damage, either at the time of loading or after varying delays. Fires caused by lithium batteries are thus an increasing hazard in recycling operations, as described in US EPA report #EPA 530-R-21-002.

Lithium batteries and devices containing lithium batteries can be detected visually by human operators or by cameras using advanced image processing, but accurate identification is complex, and in a large waste stream there is often no line of sight to a large fraction of the total volume of the stream. Other techniques, such as magnetic induction, have been explored for battery detection, but cannot easily be implemented on the tipping floor. Detection at conveyorized handling stations is more readily performed, but is too late to protect the facility from fires on the tipping floor. Therefore, an improved method of lithium ion battery detection and classification is required to protect recycling and waste handling facilities.

It is desirable to have methods, apparatuses, and systems for detecting the presence of a tag attached to a battery within a receptacle received by a vehicle.

### SUMMARY

An embodiment includes a vehicle. The vehicle includes a load arm configured to receive a receptacle, a first detector oriented relative to the load arm to receive a first wireless signal when the load arm is in a first position, a second detector oriented relative to the load arm to receive a second wireless signal when the load arm is in a second position, and a controller configured to detect presence of a tag attached to a specific object within the receptacle based on the received signal strengths of the first wireless signal and the second wireless signal.

Another embodiment includes a method of detecting presence of a tag attached to a specific object within a receptacle received by a load arm of a vehicle. The method includes receiving, by a first detector associated with the vehicle, a first wireless signal when a load arm of the vehicle is in a first position, receiving, by a second detector associated with a vehicle, a second wireless signal when the load arm is in a second position, and detecting, by a controller, presence of a tag attached to a specific object within the receptacle based on the received signal strengths of the first wireless signal and the second wireless signal.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a delivery truck that dumps recycling stream on a tipping floor, and the recycling stream is transferred by front loader to conveyorized transport and sorting operations, according to the prior art.

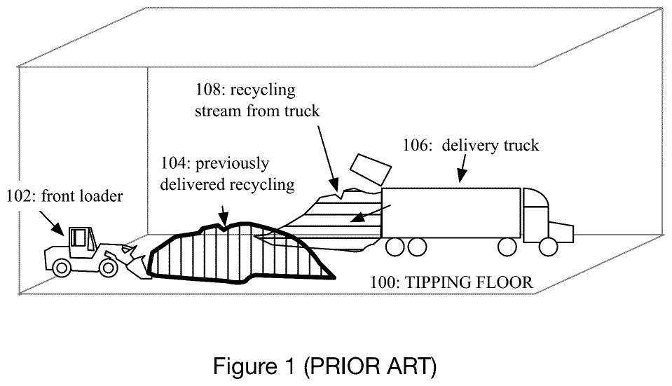

FIG. 2 shows a typical example of voltage versus state of charge, according to an embodiment.

FIG. 3 shows the behavior of conventional 18650 battery cells as the temperature is ramped at a slow rate (2° C. per minute in this case), according to an embodiment.

FIG. 4 shows an internal battery resistance for Panasonic 18650 lithium ion cell, according to an embodiment.

FIG. 5 shows an exemplary passive tag attached to an exemplary lithium ion pouch battery, according to an embodiment.

FIG. 6 shows an exemplary active beacon and antenna mounted on a typical lithium ion pouch battery, according to an embodiment.

FIGS. 7 (a) and 7 (b) show a vehicle that is configured to detect the presence of an active beacon attached to a specific object within a bin received by a load arm of the vehicle, according to an embodiment. FIGS. 7 (c) and 7 (d) show a vehicle that is configured to detect the presence of a passive tag attached to a specific object within a bin received by a load arm of the vehicle, according to another embodiment.

FIGS. 8 (a) and 8 (b) show a vehicle that is configured to detect the presence of an active beacon attached to a specific object within a bin received by a load arm of the vehicle, according to another embodiment. FIGS. 8 (c) and 8 (d) show a vehicle that is configured to detect the presence of a passive tag attached to a specific object within a bin received by a load arm of the vehicle, according to another embodiment.

FIGS. 9 (a) and 9 (b) show a vehicle that is configured to detect the presence of an active beacon attached to a specific object within a bin received by a load arm of the vehicle, according to another embodiment.

FIGS. 10 (a) and 10 (b) show a vehicle that is configured to detect the presence of a passive attached to a specific object within a bin received by a load arm of the vehicle, according to another embodiment.

FIG. 11 shows a flow chart that includes steps of a method of detecting the presence of a tag attached to a specific object within a receptacle received by a load arm of a vehicle, according to an embodiment.

FIG. 12 shows a flow chart that includes steps of a method of detecting the presence of an active beacon attached to a specific object within a bin received by a load arm of a vehicle, according to an embodiment.

### DETAILED DESCRIPTION

The embodiments described include methods, apparatuses, and systems for detecting the presence of a tag attached to a battery within a receptacle received by a vehicle. For an embodiment, the receptacle contains collected recycling and/or disposal materials. For an embodiment, the receptacle includes a bin. For an embodiment, the receptacle includes a dumpster. However, the receptacle can include other types of containers as well. For embodiment, the receptacle is made of metal. For an embodiment, the receptacle is made of plastic. It is to be appreciated that receiving signals from a tag within the receptacle is different between metallic and plastic receptacles. For an embodiment, the tag includes a passive tag. For an embodiment, the tag includes an active tag or active beacon. For an embodiment, the tag includes an RFID (Radio-Frequency Identification) tag or other radio identification device.

For an embodiment, the receptacle comprises a bin fabricated from a plastic or carbon-based polymer mixture, containing materials intended to be recycled or disposed of after collection. The bin may have a manually removable cover or may be covered with one or more hinged lids that open to allow gravitationally driven removal of the contents when the bin is dumped into a truck.

For an embodiment, a receptacle comprises a dumpster fabricated from steel or other metallic structure, optionally including one or more covers composed of plastic or carbon-based polymer mixtures which open to allow dumping of the contents into a truck.

### Passive Tag

As previously described, for an embodiment, the tag includes a passive tag. For an embodiment, the passive tag includes a UHF RFID tag compliant with ISO-18000-63, consisting of an integrated circuit and an antenna on a substrate, typically a commercial carbon polymer. For an embodiment, the passive tag is mechanically attached to the battery. For an embodiment, attachment may employ conventional adhesives holding the substrate to the surface of a location on a battery patch, battery circuitry, or other mechanically integrated battery components. For an embodiment, the tag may also be placed on a separate structure or substrate mechanically attached to the battery. For an embodiment, the antenna may be an independent conductive structure designed for operation in close proximity to a conducting metallic surface represented by the battery structure. For an embodiment, the antenna may be a conductive structure designed to operate in non-conductive environments with appropriate tag placement relative to the conductive components of the battery.

For an embodiment, the optimal location or locations for tag placement is determined by experiment or electromagnetic modeling for each combination of tag type and battery type.

### Active Tag

As previously described, for an embodiment, the tag includes an active tag (beacon). Active radio beacons (active tags) are used for identification and location of objects. In typical applications for active beacons, the beacon is powered from a very small battery such as a coin cell, from a photovoltaic source, or some other very limited power source, representing a serious limitation on the ability of the beacon to transmit. However, if an active beacon is employed to identify a hazardous battery, the task of the beacon is to identify a battery with sufficient capacity to represent a significant flammability threat. The capacity of such batteries is generally in the range of a watt-hour or greater. For detection scenarios relevant to recycling fire safety, a beacon may be sent up to 5 times per second. The power associated with transmission is approximately 0.2 milliW. Typical small 18650 lithium cells (roughly the smallest size that might be considered as representing a flammability hazard) have capacities exceeding 1 A-h or 3.5 W-h. The resulting endurance for a beacon attached to a single 18650 cell is approximately 2 years, and in almost all relevant cases a number of cells would be placed in a single battery rack. Thus, the beacon represents a completely insignificant additional load for any large battery pack, and plays a negligible role in overall battery power consumption for typical high-power applications, while remaining active for identification use until long after the final battery charging operation.

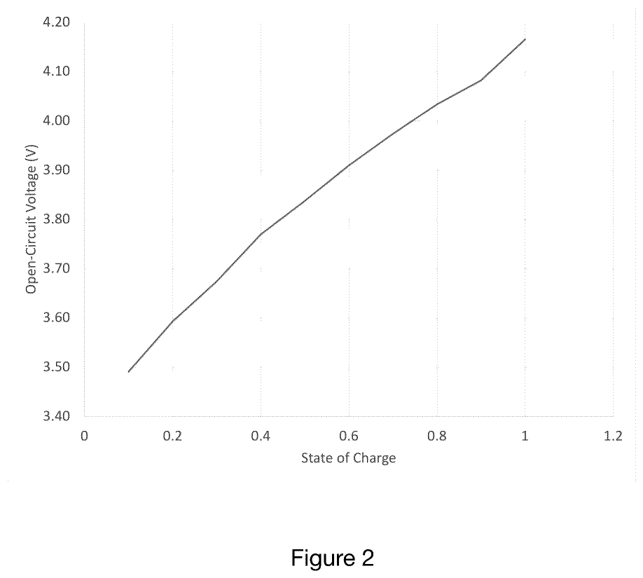

Single-cell lithium ion batteries have an output voltage exceeding 3 volts until the state of charge has fallen to well below 10%. FIG. 2 shows a typical example of voltage vs. state of charge, according to an embodiment.

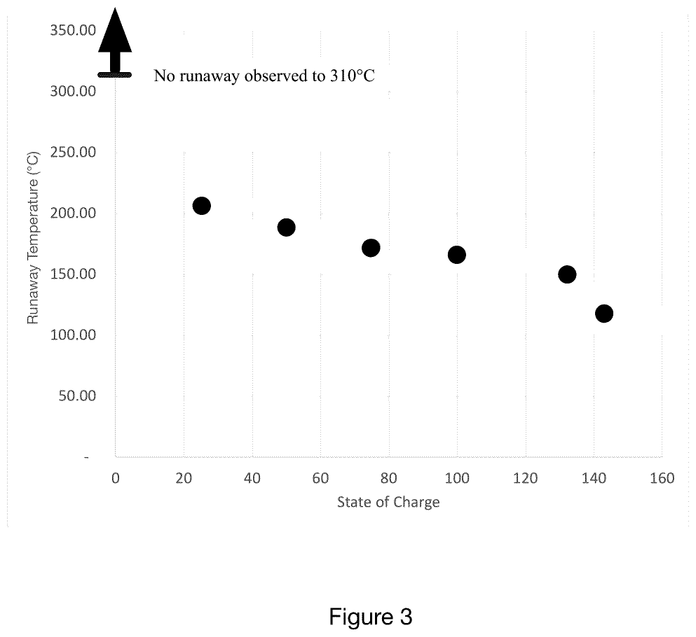

The hazard from a battery is greatly reduced when the state of charge is below 10%. For example, FIG. 3 shows the behavior of conventional 18650 battery cells as the temperature is ramped at a slow rate (2° C. per minute in this case), according to an embodiment. Thermal runaway at 25% state of charge is not observed until more than twice the ramp time for a fully-charged battery, and is not observed at all for state of charge=0. Therefore, it is apparent that any lithium ion battery cell that has sufficient state of charge to represent a significant thermal hazard will product at least 3 volts at its terminals, typically sufficient for an active radio beacon to operate. Analogous behavior is expected for larger packs consistent of multiple cells connected in series or parallel. For an embodiment, the beacon (active tag) is powered by the battery it labels or is attached to.

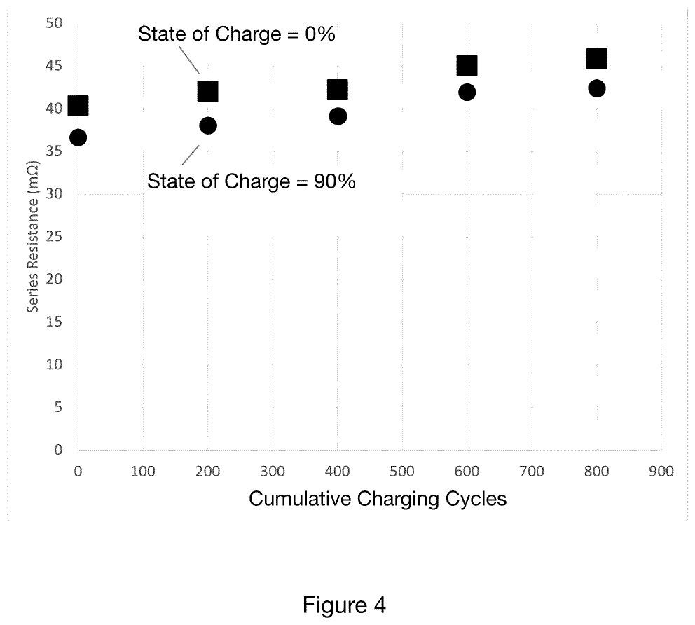

Low states of charge are associated with increased internal battery resistance, but the increase is modest. FIG. 4 shows an internal battery resistance for Panasonic 18650 lithium ion cell, according to an embodiment. The internal resistance of a battery that has experienced multiple charging cycles and is nearly discharged has risen to about 46 milliOhms, compared to the minimum observed value of about 36 milliOhms. If a beacon draws a current on the order of 10 mA when it is transmitting, the associated voltage drop is approximately 0.5 mV, and is negligible compared to the voltage margin available for a typical beacon, which requires on the order of 1.2 volts to operate.

It is therefore apparent that a typical low-power radio beacon powered by any large lithium ion battery is capable of transmitting a warning beacon any time the battery represents a significant flammability hazard. However, in order to assure detection when needed, beacons can transmit at power levels that provide tens or even hundreds of meters of detection range in open space, and many more batteries will be in use at any given time than in recycling or disposal streams. Therefore, if batteries are marked with continuously-broadcasting active beacons, means for distinguishing between beacons in the collected recycling or disposal stream and those in the outside ambient are needed. Further, if a passive tag is attached to a battery, the passive tag will identify a battery even if the battery is discharged and not very dangerous. If the battery is to be recycled, this is a useful capability for recycling.

In order to reliably detect and locate flammable lithium batteries before a fire can occur, at least some of the disclosed embodiments employ an active beacon transmitter powered by the lithium ion battery. At least some of the described embodiments presume industrial and regulatory agreement to attach such beacons to all lithium ion batteries regarded as representing a significant flammability risk at end-of-life. This approach depends on the fact that lithium ion batteries large enough to represent a substantial fire risk have high total energy capacity and are used to power large systems with substantial power requirements. A radio beacon powered by the battery can transmit continuously through the life of the battery, without representing a significant drain on its capacity in comparison to the intended loads. It is well known that the flammability risk of a battery is dependent on the state of charge (SOC). Thus, if the beacon is designed so as to operate at least until the state of charge has fallen to a safe level, indicated by a low battery output voltage provided to the beacon, the beacon will provide a warning as long as the battery is dangerous.

Any or all of trucks (vehicles) collecting recycled materials, tipping floors where recycled materials are dumped for processing, and conveyorized lines where materials are separated, can be equipped with receivers capable of detecting signals from tags (passive tags or active tags (active beacons)) indicating the presence of a potentially hazardous lithium ion battery. In order to detect only hazardous batteries which are included in the recycling stream, the disclosed embodiments include specific antenna configurations that are proposed for trucks (vehicles) collecting recycled materials. Various methods can then be used to locate and remove the hazardous battery, reducing fire risk and optionally permitting safe recycling of the battery itself.

A precondition for practice of at least some of the described embodiments is the application of industry-standard active beacons to substantially all hazardous lithium ion batteries. A wide variety of commercial radio beacon chips and packaged parts exist, typically operating under standard communications protocols. The active tags (active beacons) of the described embodiments can be based on the Bluetooth Low Energy (BTLE) standard and IEEE 802.15.1, but other protocols, such as IEEE 802.11 (Wi-Fi) or 802.15.4, could be used. Each protocol offers differing benefits for identifying hazardous batteries, but agreement upon a single protocol is an optimal precondition for reliable detection.

A BTLE beacon can be configured to transmit a beacon periodically. Beacon packets can contain up to 37 bytes of payload (296 bits), which is easily sufficient to contain a unique identifier. Various standards exist for defining beacon format; for example, the Eddystone-UID format provides a unique identifier for a beacon transmitter. While not indispensable to the practice of the described embodiments, it is helpful to obtain agreement from the relevant standards and industry organizations upon a unique identification (UID) for beacons, to unambiguously indicate the presence of an attached hazardous lithium ion battery. In this fashion, a receiver could search specifically for hazardous batteries from amongst the various BTLE beacons it might receive. Further, for an embodiment, passive tags could also or alternatively be used to mark hazardous batteries, using e.g. UHF RFID tags conforming to ISO 18000-63 or a similar standard.

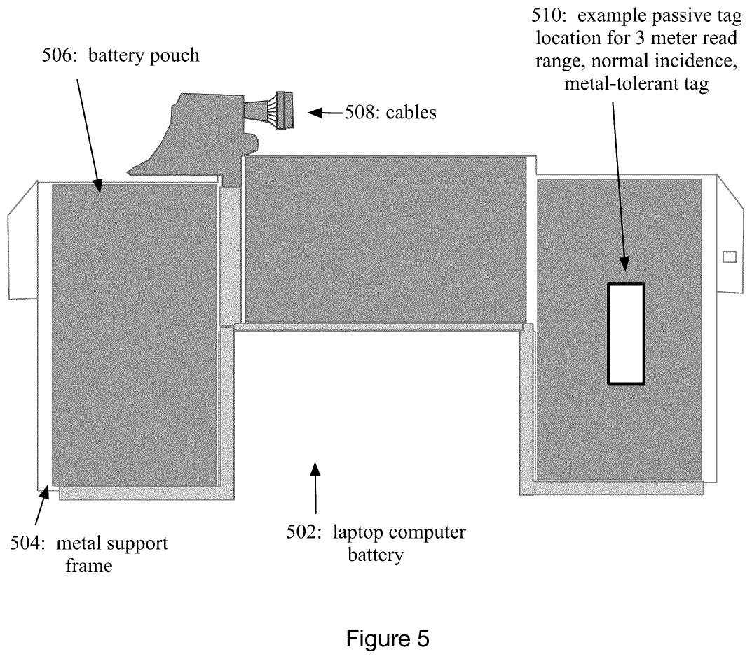

FIG. 5 shows an exemplary passive tag 510 attached to an exemplary lithium ion battery 502, comprising a metal support frame 504 on which are placed battery pouches 506 with interconnecting cables and electrical interface 508, according to an embodiment. It is to be understood that attachment can vary between different types of tags and batteries. The passive tag must be attached to the battery. Lithium ion pouch batteries contain conductive electrodes as well as, in many cases, a conductive frame or outer shell. Conductive materials in close proximity to an antenna have strong effects on the operation of the antenna. Thus, the range at which the passive tag can be detected by a reader is a very strong function of the specific tag geometry and placement on the battery structure. At least some embodiments include determining optimal attachment location by empirical optimization and/or detailed electromagnetic modeling. The optimal attachment location is likely to differ for each tag antenna design and each battery design.

For an embodiment, the lithium ion battery may be a pack composed of numerous cylindrical lithium ion cells, such as 18650 cells. In such a case, it may be advantageous to attach the tag (passive tag or active tag) to the container in which the batteries are placed rather than directly on a 18650 cell.

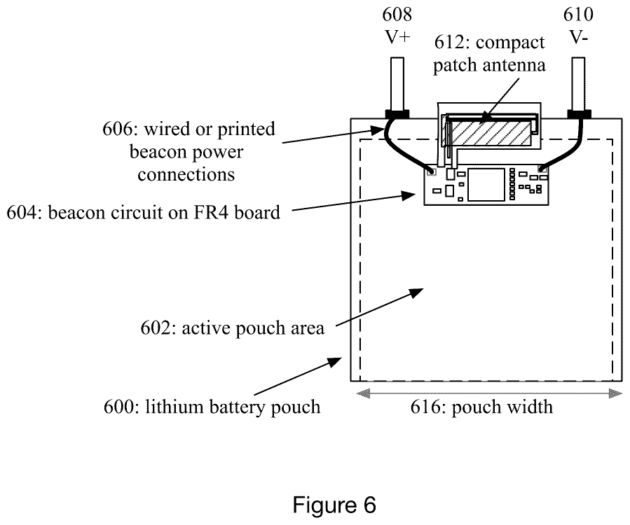

FIG. 6 shows an exemplary active beacon 604 and antenna 612 mounted on a typical lithium ion pouch battery 600, according to an embodiment. The core of the beacon 604 is an integrated circuit, typically packaged as a wafer-level chip-scale package, or a standard component package. A high-precision frequency reference, typically a quartz crystal, is needed to ensure accurate frequency control of transmissions and compliance with FCC regulations for unlicensed operation. Discrete capacitors, resistors, and optionally inductors may be used for filtering inputs and outputs. The resulting sizes for beacon circuit boards 604 vary from about 2-4 cm by 1-4 cm, and can easily be fit within the size of a typical large pouch battery 600. Robust electrical connections 606, either wired or printed, must be provided, so that the beacon is powered (by V+608 and V−610 of the lithium ion pouch battery 600) whenever the battery state of charge is sufficient to represent a flammability hazard. The lithium ion pouch battery 600 includes an active pouch area 602 and pouch width 616. Beacons may be attached to larger battery packs with higher output voltages. Beacons may be wired to employ only a portion of the full battery pack at an appropriate voltage, or voltage conversion techniques can be used to reduce the applied voltage from the full pack to an appropriate voltage for the beacon circuitry.

For an embodiment, the active beacon (such as the exemplary beacon and antenna of FIG. 6) is powered by the potentially hazardous battery (such as the lithium ion pouch battery 600) it is intended to identify, providing a transmitted signal by the active beacon when the battery has sufficient state of charge to represent a flammability hazard. That is, for this embodiment, the active beacon is attached to, and powered by, the battery.

An antenna must be provided for signal transmission. The BTLE standard operates in the 2.45 GHz range, where wavelength is approximately 12 cm. Effective antennas can be constructed in a space on the order of 2-4 cm on a side or less.

Thus, a beacon (active tag) can be physically small enough to conveniently attach to any battery pack or pouch large enough to represent a substantial hazard. The beacon may be configured to transmit at periodic intervals as long as it is active and powered. The optimal beacon transmit period varies slightly depending on the recycling operation at which the beacon is to be detected, but in all cases except high-speed conveyorized sorting, a beacon period 0.2 to 1 second should be sufficient to provide a received with adequate warning of the presence of a potentially hazardous battery. As noted above, transmission of beacons at these periods represents a very small load for large battery packs. Transmit power in typical commercial beacons may be adjusted to as low as −40 dBm, and as high as +5 dBm. However, transmission at power less than about −15 to −20 dBm would fail to ensure detection, particularly in cases where the transmit antenna is occluded by neighboring materials (e.g. aluminum foil) or damaged. Transmission at 0 to +5 dBm is preferred for reliable detection of hazardous batteries, but will provide ranges of tens of meters, resulting in the likelihood of false positive detection from ambient beacons.

Thus, it is practical to attach an active beacon to any battery pack large enough to represent a flammability hazard, without impacting the endurance of the supported equipment. In an embodiment, the beacon integrated circuit and reference oscillator may be incorporated into a flexible substrate, upon which the antenna is printed by standard metal deposition/etch or additive manufacturing. The battery pack must then be modified to incorporate mechanical support for the beacon, and electrical connection to the active terminals of the battery. In the case where a battery pack is composed of multiple pouches, and where each individual pouch is large enough to represent a substantial flammability hazard, a beacon may be attached to each pouch. If a beacon becomes detached from the battery pack, it has no power source and will not transmit, avoiding false positive detection errors.

In the case where tags (passive tag or active tags (beacons)) have been attached to substantially all hazardous batteries, it is then necessary to detect the presence of these tags, and distinguish between tags that correspond to hazardous batteries collected in a recycling or disposal stream, and other batteries in normal use. Simple and reliable means of location must be employed to determine when a detected tag arises from the collected recycling or disposal materials.

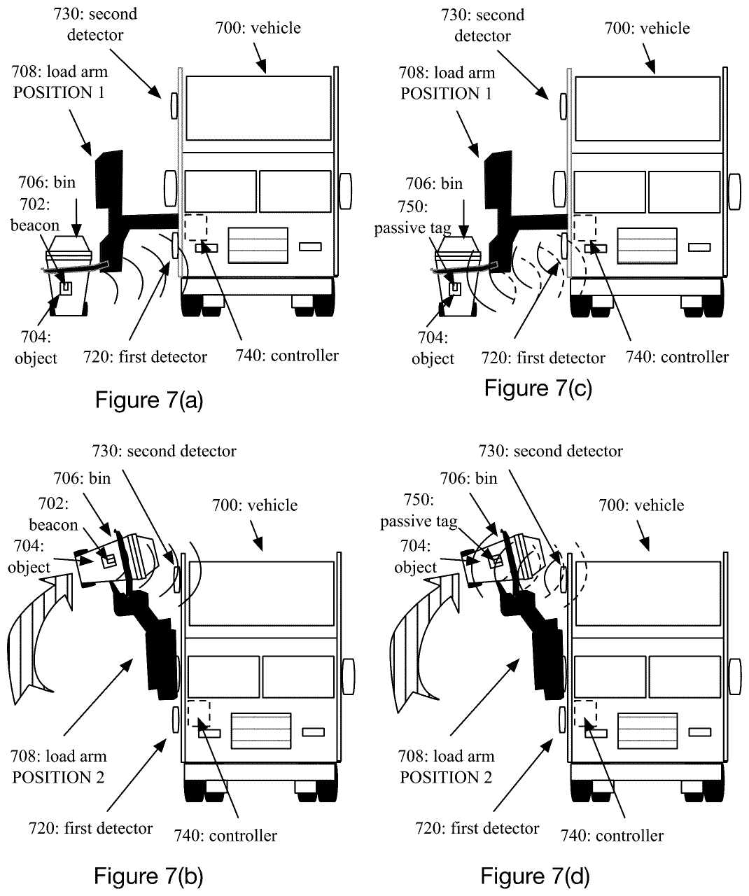

FIGS. 7 (a) and 7 (b) show a vehicle 700 that is configured to detect the presence of a tag (active beacon 702) attached to a specific object 704 within a bin (or more generally, a receptacle) 706 received by a load arm 708 of the vehicle 700, according to an embodiment. FIGS. 7 (c) and 7 (d) show a vehicle that is configured to detect the presence of a tag (passive tag 750) attached to a specific object within the bin 706 received by the load arm 708 of the vehicle 700, according to another embodiment.

As shown, the vehicle 700 includes the load arm 708 configured to receive the bin 706. Further, for an embodiment, the vehicle 700 includes a first detector 720 oriented relative to the load arm 708 to receive a first wireless signal when the load arm 708 is in a first position P1 (POSITION 1 of FIG. 7 (a) and FIG. 7 (c)). Further, the vehicle 700 includes a second detector 730 oriented relative to the load arm 708 to receive a second wireless signal when the load arm 708 is in the second position P2 (POSITION 2 of FIG. 7 (b) and FIG. 7 (d)). Further, for an embodiment, the vehicle 700 includes a controller 740 configured to detect presence of the tag 702 attached to the specific object 704 within the bin 706 based on the received signal strengths of the first wireless signal, and the second wireless signal.

As will be described, for an embodiment, the tag includes the passive tag 750. For an embodiment, detecting the presence of the passive tag 750 based on the received signal first wireless signal and the second wireless signal includes transmitting, by the first detector, a first continuous powerup signal, thereby initiating backscatter communication with the passive tag 750 that includes a request that the passive tag 750 backscatter its unique identification code when the load arm 708 is in the first position, wherein the first wireless signal includes a first backscatter signal from the passive tag 750, and transmitting, by the second detector, a second continuous powerup signal, thereby initiating backscatter communication with the passive tag 750 that includes a request that the passive tag 750 backscatter its unique identification code when the load arm is in the second position, wherein the second wireless signal includes a second backscatter signal from the tag.

As will be described, for an embodiment, the tag includes the active beacon 702. For an embodiment, the active beacon 702 is configured to transmit wireless signals.

For another embodiment, the first detector 720 is oriented relative to the load arm 708 to receive a first wireless signal when the load arm 708 is in a first position P1 (POSITION 1 of FIG. 7 (a) and FIG. 7 (c)) and receive a second wireless signal when the load arm 708 is in a second position P2 (POSITION 2 of FIG. 7 (b) and FIG. 7 (d)). Further, the second detector 730 is oriented relative to the load arm 708 to receive a third wireless signal when the load arm 708 is in the first position P1 and receive a fourth wireless signal when the load arm 708 is in the second position P2. Further, the vehicle 700 includes a controller 740 configured to detect presence of the tag (passive beacon 750 or active beacon 702) attached to the specific object 704 within the bin 706 based on the received signal strengths of the first wireless signal, the second wireless signal, the third wireless signal and the fourth wireless signal.

It is to be understood that various relationships between the received signal strengths of the first wireless signal, the second wireless signal, the third wireless signal and the fourth wireless signal can be analyzed to determine the presence of the tag (passive beacon 750 or active beacon 702). For an embodiment, the controller 740 is further configured to detect presence of the tag (passive beacon 750 or active beacon 702) attached to the specific object 704 within the bin 706 when a change between the received signal strengths of the first wireless signal, the second wireless signal, and a change between the received signal strengths of third wireless signal and the fourth wireless signal are greater than a preselected threshold. For an embodiment, a preselected threshold is selected by experimentally determining or testing of reception of the wireless signals of the tag (passive beacon 750 or active beacon 702) against tags not located in the bin. For an embodiment, the change in the first and second wireless signals received by the first detector from position 1 to position 2, and the change in the third and fourth wireless signals received by the second detector from position 1 to position 2, are both larger than a threshold and are opposite in sign, That is, the changes in the first and second wireless signals received by the first detector are anti-correlated with the third and fourth wireless signals received by the second detector.

For an embodiment, in order to reduce the number of false positive detections in the presence of the tag (passive beacon 750 or active beacon 702), the controller 740 is further configured to confirm the detected presence of the tag (passive beacon 750 or active beacon 702). For an embodiment, confirming the detected presence of the tag (passive beacon 750 or active beacon 702) includes the controller 740 being configured to control additional rotation of the load arm 708 and confirm the detected presence based on additional signals sensed by the first and second detectors 720, 730. For an embodiment, the confirmation includes the controller 740 being further configured to control additional lift of the load arm 708 and confirm the detected presence based on additional signals sensed by the first and second detectors 720, 730.

For an embodiment, the controller is further configured to detect presence of the tag (passive beacon 750 or active beacon 702) attached to the specific object within the bin when a difference in received signal strength between the first wireless signal and the second wireless signal is greater than a difference in received signal strength between the third wireless signal and the fourth wireless signal.

For at least some embodiments, the bin 706 is made of a non-metallic material. This ensures that the first detector 720 and the second detector second detector 730 can receive the wireless signals from the tag (passive beacon 750 or active beacon 702).

For an embodiment, it is assumed that the first wireless signal received by the first detector 720 and the third wireless signal received by the second detector 730 originated (transmitted from) from the tag (passive beacon 750 or active beacon 702) when the load arm 708 is in the first position P1. However, it is to be understood that an alternate embodiment includes the load arm 708 being in a third position P3 that is different than the first position P1 when the wireless signal or backscatter signal is transmitted from the tag (passive beacon 750 or active beacon 702) and results in the third wireless signal received by the second detector 730. Further, for an embodiment, it is assumed that the second wireless signal received by the first detector 720 and the fourth wireless signal received by the second detector 730 originated (transmitted from) from the tag (passive beacon 750 or active beacon 702) when the load arm 708 is in the second position P2. However, it is to be understood that an alternate embodiment includes the load arm 708 being in a fourth position P4 that is different than the second position P2 when the wireless signal is transmitted from the active beacon 702 and results in the fourth wireless signal received by the second detector 730.

For an embodiment, the active beacon 702 is configured to transmit wireless signals. For an embodiment, the active beacon 702 is a previously described beacon and antenna mounted on a typical lithium ion battery. For an embodiment, the active beacon 702 includes an identifying number, and the identifying number comprises a specific sequence indicating presence of a hazardous battery. For an embodiment, the active beacon periodically transmits wireless signals.

For an embodiment, the first detector 720 and the second detector 730 are each a previously described Bluetooth Low Energy (BTLE) receiver.

As shown in FIGS. 7 (a), 7 (b), 7 (c), 7 (d), for an embodiment, the second detector 730 is located proximate to a tipping position 740 of the load arm 708, and the first detector 720 is located proximate to a lowest position 750 of the load arm 708.

As previously described, for an embodiment, the first wireless signal received by the first detector 720 and the third wireless signal received by the second detector 730 originated (transmitted from) from the tag (passive tag 750 of FIGS. 7 (c), 7 (d)) or the active beacon 702 of FIGS. 7 (a), 7 (b)) when the load arm 708 is in the first position P1. That is, for an embodiment, the first wireless signal and the third wireless signal originate from the tag attached to the specific object but propagate through different transmission paths. It is to be understood that many propagation paths will typically exist for both the first wireless signal and the third wireless signal, but the propagation paths for each will be different. Similarly, for an embodiment, the second wireless signal and the fourth wireless signal originate from the tag attached to the specific object but propagate through different transmission paths.

For an embodiment, the specific object is a battery, and a tag (active beacon) receives electrical power from the battery. That is, for an embodiment, the specific object being detected is the battery, and more specifically for an embodiment, the active beacon is attached to and powered by the battery the active beacon is attached to. As described, the battery is only potentially dangerous when the battery is still carrying a charge. Therefore, the active beacon only transmits wireless signals when the battery is still carrying a charge and potentially dangerous.

An implementation of the embodiments of FIGS. 7 (a), 7 (b), 7 (c), 7 (d) includes a detection apparatus for tags (such as, passive tag 750 or active beacon 702) in plastic collection bins (such as bin 706) when those bins are collected by a side-loader collection truck (vehicle 700). The detection apparatus employs two directional antennas (the first detector 720 and the second detector 730) mounted to the side of the collection truck (vehicle 700), one (first detector 720) at the level of the bin 706 when initially picked up by the container arm (load arm 708), and a second antenna (second detector 730) at a higher level where it primarily views the path of the bin 706 as the bin 706 is raised to be dumped into the side-loader truck (vehicle 700). The antennas (the first detector 720 and the second detector 730) may be connected to a single receiver and used alternately, or each antenna (the first detector 720 and the second detector 730) may be connected to a separate receiver. The wireless signals of the tag (passive tag 750 or active beacon 702) indicating the presence of a hazardous battery or pack in the bin 706 will be received by both antennas (the first detector 720 and the second detector 730). The received signal strength will vary in a fashion that corresponds to the lift path in the truck (vehicle 700). Other signals from tags present in the surroundings, such as phones or laptop computers carried by pedestrians or within cars or public transit, within homes, or in industrial settings, will have a received signal strength that is very unlikely to be correlated to the lift operation (change in the positions (such as, positions P1, P2) of the load arm 708) in a similar fashion. Therefore, it is straightforward to employ automated techniques to recognize that an active beacon 702 representing a potential flammability hazard is in fact contained within the bin 706. Once that is determined, the truck (vehicle 700) driver may be warned and enabled to return the bin 706 to ground level and check for the hazardous battery. The check may optionally involve such means as a handheld receiver with a directional antenna, or may simply involve return of the bin 676 until the user removes the hazardous materials.

For an embodiment, the load arm 708 is configured to rotate through a sequence of positions. The first detector and the second detector are configured measure received signal strengths of wireless signals from the tag received at each of the sequence of positions of the load arm. The controller is configured to multiply the received signal strength of each of the sequence of positions with a corresponding function of the angle of each of the sequence of positions to form a measure of correlation of a signal sequence and the sequence of positions, and detect and report the presence of the tag when a magnitude of the measure of the correlation exceeds a correlation threshold for both the received signal strengths of the wireless signals received by the first detector and the second detector.

For an embodiment, the active beacon 702 is configured to transmit at a time interval such that multiple signals are received during a sequence of positions, and the sequence of received signal strength can be correlated with the sequence of positions for the first detector and the second detector. That is, the active beacon 702 transmits the wireless signal frequently enough that different wireless signals can be detected at the first position and the second position. Similarly, for an embodiment, the reader (detectors) instructs the passive tag 750 to backscatter identifying signals at a time interval such that multiple signals are received during a sequence of positions, and the sequence of received signal strength can be correlated with the sequence of positions for the first detector and the second detector. That is, the passive tag 750 transmits the wireless backscatter signal frequently enough that different wireless signals can be detected at the first position and the second position.

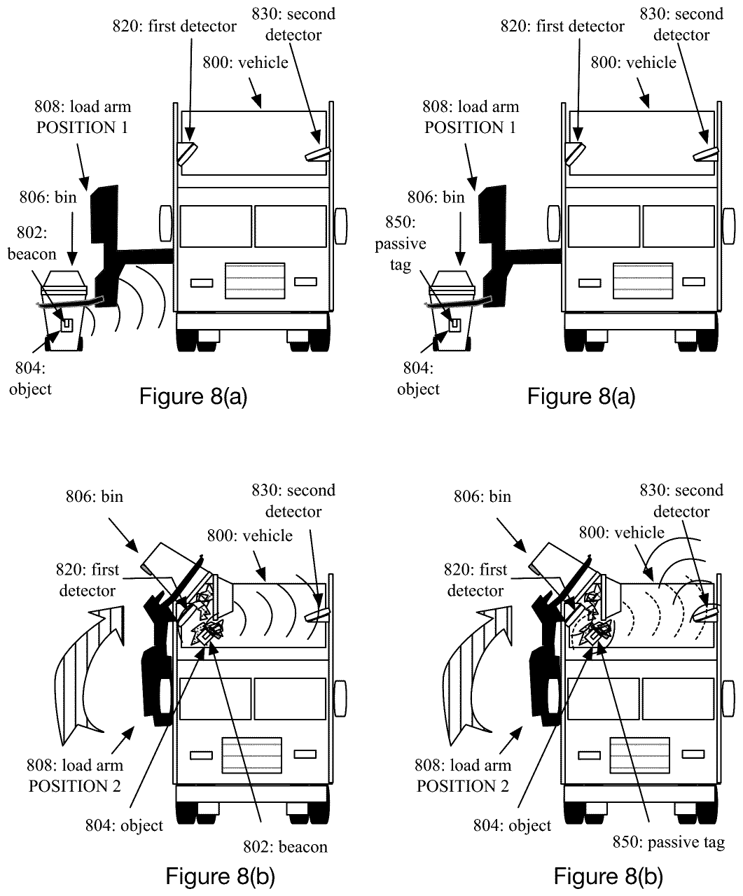

FIGS. 8 (a), 8 (b), 8 (c), 8 (d) show a vehicle 800 that is configured to detect the presence of a tag (passive tag 850 of FIGS. 8 (c), 8 (d) or active beacon 802 of FIGS. 8 (c), 8 (d)) attached to a specific object 804 within a bin (or more generally, a receptacle) 806 received by a load arm 808 of the vehicle 800, according to another embodiment.

As shown, for an embodiment, the first detector 820 is located and oriented to sense wireless signals of the tag (passive tag 850 or active beacon 802) after contents of the bin 806 including the tag (passive tag 850 or active beacon 802) has been dumped from the bin 806 and the second detector 830 is located and oriented to detect signals of tags during a lift operation of the load arm 808.

An implementation of the embodiments of FIGS. 8 (a), 8 (b), 8 (c), 8 (d) include antennas (the first detector 820 and the second detector 830) placed on the sides of the interior of a side-loader truck (vehicle 800). One or more antennas are directed to receive signals primarily from the material being dumped from bins, and material previously received. One or more antennas are directed upwards, to receive signals primarily from outside the truck. By comparing RSSI history, signals from beacons contained in bins can be easily distinguished from those originating outside the truck (vehicle 800) and unrelated to the recycling collection operation. This approach has the advantage that the metallic walls of the side-loader truck (vehicle 800) will provide considerable shielding from ambient beacons, greatly reducing the likelihood that a beacon received from a transmitter elsewhere in the environment will be incorrectly identified as being in a bin 806 or in the truck (vehicle 800).

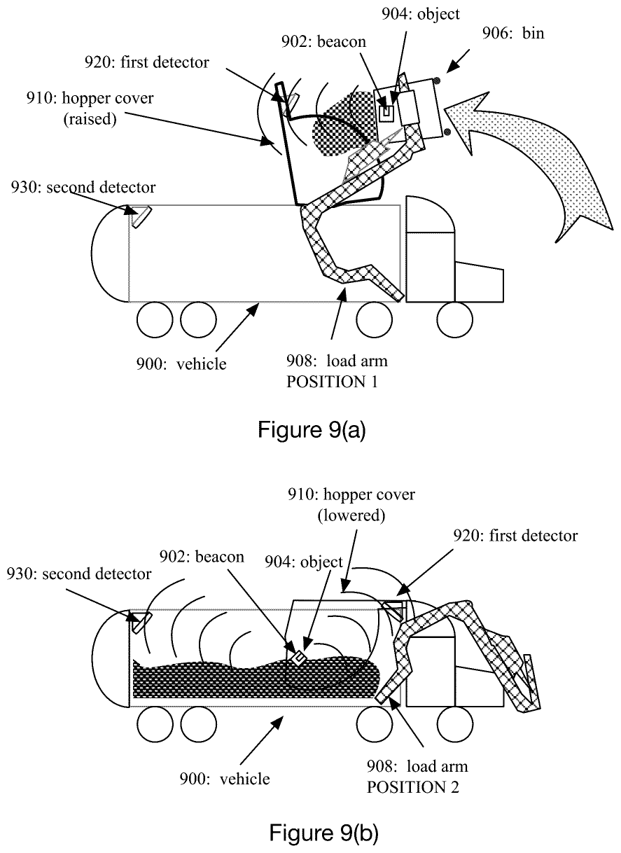

FIGS. 9 (a) and 9 (b) show a vehicle 900 that is configured to detect the presence of an active tag (beacon 902) attached to a specific object 904 within a bin (or more generally, a receptacle) 906 received by a load arm 908 of the vehicle 900, according to another embodiment. For an embodiment, the second detector 930 is located within a hopper of the vehicle 900 and the first detector 920 is located on a pickup arm (load arm 908) or a hopper cover 910.

An implementation of the embodiments of FIGS. 9 (a) and 9 (b) includes a front-loader truck (vehicle 900) equipped with one or more antennas (the first detector 920 and the second detector 930) contained within the enclosed collection area, and optional antennas on the hopper cover facing the dump path. A configuration with a hinged cover is shown; alternative front-loader configurations with sliding hopper covers may also be used, with appropriate modification to the antenna placement. The antennas that are contained in the collection area receive only beacons from transmitters (active beacons) contained within the collection area, particularly when the hopper cover is lowered. The optional antennas mounted on the hopper cover may detect beacons from the ambient during the collection operation, but the RSSI history during the dump operation, combined with that of the internal antennas, may be employed to identify beacons which are contained in the dumpster as it is dumped into the front-loader.

The embodiments of FIGS. 9 (a) and 9 (b) provide very few false positive responses, as external beacons will rarely be detected when the hopper cover is closed.

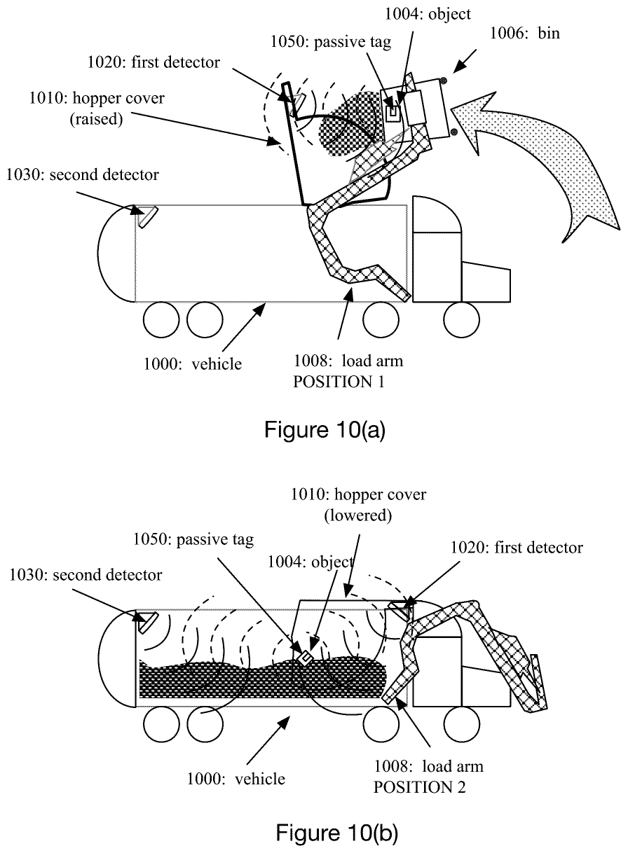

FIGS. 10 (a) and 10 (b) show a vehicle 1000 that is configured to detect the presence of a passive tag 1050 attached to a specific object 1004 within a bin (or more generally, a receptacle) 1006 received by a load arm 1008 of the vehicle 1000, according to another embodiment. For an embodiment, the second detector 1030 is located within a hopper of the vehicle 1000 and the first detector 1020 is located on a pickup arm (load arm 1008) or a hopper cover 1010.

An implementation of the embodiments of FIGS. 10 (a) and 10 (b) includes a front-loader truck (vehicle 1000) equipped with one or more antennas (the first detector 1020 and the second detector 1030) contained within the enclosed collection area, and optional antennas on the hopper cover facing the dump path. A configuration with a hinged cover is shown; alternative front-loader configurations with sliding hopper covers may also be used, with appropriate modification to the antenna placement. The antennas that are contained in the collection area receive only signals from transmitters (passive tag) contained within the collection area, particularly when the hopper cover is lowered. The optional antennas mounted on the hopper cover may detect tags from the ambient during the collection operation, but the RSSI history during the dump operation, combined with that of the internal antennas, may be employed to identify beacons which are contained in the dumpster as it is dumped into the front-loader.

The embodiments of FIGS. 10 (a) and 10 (b) provide very few false positive responses, as external beacons will rarely be detected when the hopper cover is closed.

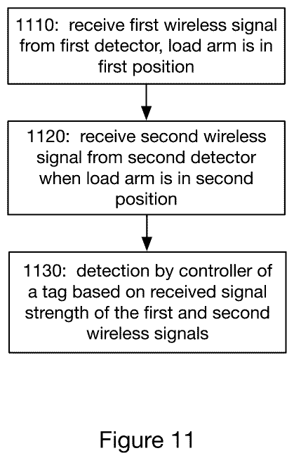

FIG. 11 shows a flow chart that includes steps of a method of detecting the presence of a tag attached to a specific object within a receptacle received by a load arm of a vehicle, according to an embodiment. A first step 1110 includes receiving, by a first detector associated with the vehicle, a first wireless signal when a load arm of the vehicle is in a first position. A second step 1120 includes receiving, by a second detector associated with a vehicle, a second wireless signal when the load arm is in a second position. A third step 1130 includes detecting, by a controller, presence of a tag attached to a specific object within the receptacle based on the received signal strengths of the first wireless signal and the second wireless signal.

### Passive Tag

As previously described, for an embodiment, the tag includes a passive tag. For an embodiment, detecting the presence of the tag based on the received signal first wireless signal and the second wireless signal includes transmitting, by the first detector, a first continuous powerup signal, thereby initiating backscatter communication with the tag that includes a request that the tag backscatter its unique identification code when the load arm is in the first position, wherein the first wireless signal includes a first backscatter signal from the tag, and transmitting, by the second detector, a second continuous powerup signal, thereby initiating backscatter communication with the tag that includes a request that the tag backscatter its unique identification code when the load arm is in the second position, wherein the second wireless signal includes a second backscatter signal from the tag. Further, for an embodiment, detecting the presence of the tag based on the received first wireless signal and the second wireless signal further includes measuring, by the first detector, an average received signal strength of the first backscattered signal, measuring, by the second detector, an average received signal strength of the second backscattered signal, verifying that the first backscatter signal and the second backscatter signal have the same unique identification code, and determining whether the tag is located within the receptacle based on comparing the average received signal strength of the first backscattered signal and the average received signal strength of the second backscattered signal.

An embodiment includes transmission the continuous power up signals (such as, the first continuous powerup signal and the second continuous powerup signal) and an inventory message sequence, according to the standard ISO18000-63 or a functionally equivalent standard, by the first detector, in order to initiate backscatter communication with the tag when the receptacle is in the first position, and requesting that the tag backscatter its unique identification code to the first detector. Further, an embodiment includes transmission of a similar continuous power up signals and inventory sequence by the second detector when the tag is in the second position, in order to initiate backscatter communication with the tag, and requesting that the tag backscatter its unique identification code to the second detector. At least some embodiments further include measurement of the average received signal strength of the first backscattered signal at the first detector, and measurement of the average received signal strength of the second backscattered signal at the second detector. At least some embodiments further include verifying that the two signals correspond to the same unique identification code. Further, at least some embodiments include comparing the averaged received signal strength of the first and second backscattered signals to determine whether the detected tag is within the receptacle.

At least some embodiments further include the first detector is further configured to receive a third wireless signal when the load arm is in the second position, and the second detector is further configured to receive a fourth wireless signal when the load arm is in the first position. Further, for an embodiment, detecting the presence of the tag based on the received signal first wireless signal, the received second wireless signal, the received signal third wireless signal, and the received fourth wireless signal, further includes transmitting, by the first detector, a third continuous powerup signal, thereby initiating backscatter communication with the tag that includes a request that the tag backscatter its unique identification code when the load arm is in the first position, wherein the third wireless signal includes a third backscatter signal from the tag, and transmitting, by the second detector, a fourth continuous powerup signal, thereby initiating backscatter communication with the tag that includes a request that the tag backscatter its unique identification code when the load arm is in the second position, wherein the fourth wireless signal includes a second backscatter signal from the tag. Further, for an embodiment, detecting the presence of the tag based on first wireless signal, the received second wireless signal, the received signal third wireless signal, and the received fourth wireless signal, further includes measuring, by the first detector, an average received signal strength of the third backscattered signal, measuring, by the second detector, an average received signal strength of the fourth backscattered signal, verifying that the third backscatter signal and the fourth backscatter signal have the same unique identification code, and determining whether the tag is located within the receptacle based on comparing the average received signal strength of the first backscattered signal, the average received signal strength of the second backscattered signal, the average received signal strength of the third backscattered signal, and the average received signal strength of the fourth backscattered signal.

### Active Tag

As previously described, for an embodiment, the tag includes an active beacon. For an embodiment, the active beacon is configured to transmit wireless signals. Further, for an embodiment, the first detector is further configured to receive a third wireless signal when the load arm is in the second position, and the second detector is further configured to receive a fourth wireless signal when the load arm is in the first position. Further, for an embodiment, the controller is further configured to detect presence of the active beacon attached to the specific object within the receptacle when a change between the received signal strengths of the first wireless signal, the third wireless signal, and a change between the received signal strengths of the second wireless signal and the fourth wireless signal are greater than a preselected threshold.

For an embodiment, the first wireless signal and the second wireless signal originate from the active beacon attached to the specific object but propagate through different transmission paths. Further, for an embodiment, the third wireless signal and the fourth wireless signal originate from the active beacon attached to the specific object but propagate through different transmission paths.

For an embodiment, the active tag (beacon) periodically transmits wireless signals. Passive beacons have no internal power source and don't transmit by themselves, only when interrogated (or at least illuminated) by an external transmitter.

For an embodiment, the specific object includes a battery, and the active tag (beacon) receives electrical power from the battery.

### Active Tag or Passive Tag

For an embodiment, the controller is further configured to confirm the detected presence of the tag, comprising the controller configured to control additional rotation of the load arm and confirm the detected presence based on additional signals sensed by the first and second detectors. For an active tag, an embodiment includes confirming the detected presence of the active beacon, including controlling additional lift of the load arm and confirming the detected presence based on additional signals sensed by the first and second detectors.

For an embodiment, the controller is further configured to detect presence of the tag attached to the specific object within the receptacle when a difference in received signal strength between the first wireless signal and the third wireless signal is greater than a difference in received signal strength between the second wireless signal and the fourth wireless signal.

For an embodiment, the second detector is located proximate to a tipping position of the load arm, and the first detector is located proximate to a lowest position of the load arm.

For an embodiment, the first detector is located and oriented to sense wireless signals of the tag (passive tag or active tag (beacon)) after contents of the receptacle including the tag have been dumped from the receptacle and the second detector is located and oriented to detect the tag during a lift operation of the load arm.

For an embodiment, the second detector is located within a hopper of the vehicle and the first detector is located on a pickup arm or a hopper cover.

For an embodiment, the tag comprises an identifying number, and the identifying number comprises a specific sequence indicating presence of a hazardous battery.

For an embodiment, the load arm is configured to rotate through a sequence of positions. Further, the first detector and the second detector are configured measure received signal strengths of wireless signals (backscatter wireless signals for passive tags and transmitted signals for active tags (beacons) received at each of the sequence of positions of the load arm. Further, the controller is configured to multiply the received signal strength of each of the sequence of positions with a function of a corresponding angle of each of the sequence of positions to form a measure of correlation of a signal sequence and the sequence of positions, and detect and report presence of the beacon when a magnitude of the measure of the correlation exceeds a correlation threshold for both the received signal strengths of the wireless signals received by the first detector and the second detector.

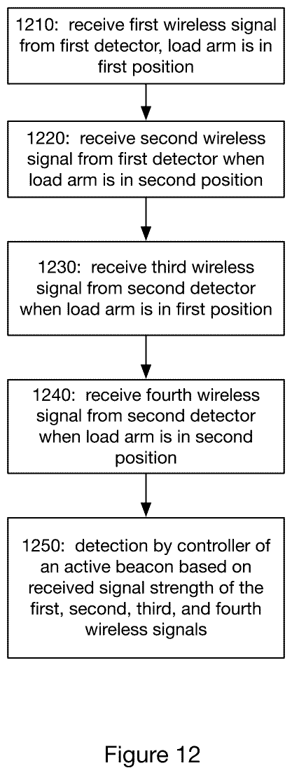

FIG. 12 shows a flow chart that includes steps of a method of detecting the presence of an active beacon attached to a specific object within a bin received by a load arm of a vehicle, according to an embodiment. A first step 1210 includes receiving, by a first detector of a vehicle, a first wireless signal when the load arm of the vehicle is in a first position. A second step 1220 includes receiving, by the first detector, a second wireless signal when the load arm is in a second position. A third step 1230 includes receiving, by a second detector of the vehicle, a third wireless signal when the load arm is in the first position. A fourth step 1240 includes receiving, by the second detector, a fourth wireless signal when the load arm is in the second position. A fifth step 1250 includes detecting, by a controller, the presence of an active beacon attached to a specific object within the bin based on the received signal strengths of the first wireless signal, the second wireless signal, the third wireless signal and the fourth wireless signal.

As previously described, an embodiment includes detecting the presence of the active beacon attached to the specific object within the bin when a change between the received signal strengths of the first wireless signal, the second wireless signal, and a change between the received signal strengths of the third wireless signal and the fourth wireless signal are greater than a preselected threshold. For an embodiment, preselected threshold is selected by experimental testing reception of the wireless signals of the active beacon against beacons not located in the bin. For an embodiment, the change in the first and second wireless signals received by the first detector from position 1 to position 2, and the change in the third and fourth wireless signals received by the second detector from position 1 to position 2, are both larger than a threshold and are opposite in sign, That is, the changes in the first and second wireless signals received by the first detector are anti-correlated with the third and fourth wireless signals received by the second detector.

As previously described, an embodiment includes confirming the detected presence of the active beacon, including controlling additional rotation of the load arm and confirm the detected presence based on additional signals sensed by the first and second detectors. As previously described, an embodiment includes confirming the detected presence of the active beacon, including controlling additional lift of the load arm and confirming the detected presence based on additional signals sensed by the first and second detectors.

As previously described, an embodiment includes detecting the presence of the active beacon attached to the specific object within the bin when a difference in received signal strength between the first wireless signal and the second wireless signal is greater than a difference in received signal strength between the third wireless signal and the fourth wireless signal.

As previously described, an embodiment includes the second detector being located proximate to a tipping position of the load arm, and the first detector being located proximate to a lowest position of the load arm. As previously described, an embodiment includes the first detector being located and oriented to sense wireless signals of the active beacon after contents of the bin including the active beacon have been dumped from the bin and the second detector being located and oriented to detect beacons during a lift operation of the load arm. As previously described, an embodiment includes the first detector being located within a hopper of the vehicle and the second detector being located on a pickup arm or a hopper cover.

As previously described, for an embodiment the active beacon is configured to transmit wireless signals. For an embodiment, the first wireless signal and the third wireless signal originate from the active beacon attached to the specific object but propagate through different transmission paths. For an embodiment, the second wireless signal and the fourth wireless signal originate from the active beacon attached to the specific object but propagate through different transmission paths. For an embodiment, the active beacon includes an identifying number, and the identifying number comprises a specific sequence indicating presence of a hazardous battery. For an embodiment, the active beacon periodically transmits wireless signals.

For an embodiment, the specific object comprises a battery, and the active beacon receives electrical power from the battery. As previously described, the active beacon only transmits wireless signals when the battery is carrying a charge and is potentially dangerous.

An embodiment further includes rotating the load arm through a sequence of positions, measuring by the first detector and the second detector received signal strengths of wireless signals received from the tag (passive tag or active tag) at each of the sequence of positions of the load arm, multiplying the received signal strength of each of the sequence of positions with a function of the corresponding angle of each of the sequence of positions to form a measure of correlation of a signal sequence and the sequence of positions, detecting and reporting presence of the beacon when a magnitude of the measure of the correlation exceeds a correlation threshold for both the received signal strengths of the wireless signals received by the first detector and the second detector.

For an embodiment, the active beacon is configured to transmit at a time interval such that multiple signals are received during a sequence of positions, and the sequence of received signal strength can be correlated with the sequence of positions for the first detector and the second detector. That is, the active beacon transmits the wireless signal frequently enough that different wireless signals can be detected at the first position and the second position. Similarly, for an embodiment, the passive tag transmits backscatter signals at a time interval such that multiple signals are received during a sequence of positions, and the sequence of received signal strength can be correlated with the sequence of positions for the first detector and the second detector. That is, the passive tag transmits the wireless signal frequently enough that different wireless signals can be detected at the first position and the second position.

Although specific embodiments have been described and illustrated, the embodiments are not to be limited to the specific forms or arrangements of parts so described and illustrated. The described embodiments are to only be limited by the claims.

What is claimed:

1. A vehicle, comprising:
a load arm configured to receive a receptacle;
a first detector oriented relative to the load arm to receive a first wireless signal when the load arm is in a first position;
a second detector oriented relative to the load arm to receive a second wireless signal when the load arm is in a second position; and
a controller configured to detect presence of a tag attached to a specific object within the receptacle based on the received signal strengths of the first wireless signal and the second wireless signal.

2. The vehicle of claim 1, wherein the tag comprises a passive tag.

3. The vehicle of claim 2, wherein detecting the presence of the tag based on the received signal first wireless signal and the second wireless signal comprises:
the first detector configured to transmit a first continuous powerup signal, thereby initiating backscatter communication with the tag that includes a request that the tag backscatter its unique identification code when the load arm is in the first position, wherein the first wireless signal includes a first backscatter signal from the tag; and
the second detector configured to transmit a second continuous powerup signal, thereby initiating backscatter communication with the tag that includes a request that the tag backscatter its unique identification code when the load arm is in the second position, wherein the second wireless signal includes a second backscatter signal from the tag.

4. The vehicle of claim 3, wherein detecting the presence of the tag based on the received signal first wireless signal and the second wireless signal further comprises:
the first detector configured to measure an average received signal strength of the first backscattered signal;
the second detector configured to measure an average received signal strength of the second backscattered signal;
the controller configured to verify that the first backscatter signal and the second backscatter signal have the same unique identification code; and
the controller configured to determine whether the tag is located within the receptacle based on comparing the average received signal strength of the first backscattered signal and the average received signal strength of the second backscattered signal.

5. The vehicle of claim 1, wherein:
the first detector is further configured to receive a third wireless signal when the load arm is in the second position; and
the second detector is further configured to receive a fourth wireless signal when the load arm is in the first position.

6. The vehicle of claim 1, wherein the tag comprises an active beacon.

7. The vehicle of claim 6, wherein:
the first detector is further configured to receive a third wireless signal when the load arm is in the second position; and
the second detector is further configured to receive a fourth wireless signal when the load arm is in the first position.

8. The vehicle of claim 7, wherein the controller is further configured to detect presence of the active beacon attached to the specific object within the receptacle when a change between the received signal strengths of the first wireless signal, the third wireless signal, and a change between the received signal strengths of the second wireless signal and the fourth wireless signal are greater than a preselected threshold.

9. The vehicle of claim 1, wherein the controller is further configured to confirm the detected presence of the tag, comprising the controller configured to control additional rotation of the load arm and confirm the detected presence based on additional signals sensed by the first and second detectors.

10. The vehicle of claim 1, wherein the controller is further configured to control additional lift of the load arm and confirm the detected presence based on additional signals sensed by the first and second detectors.

11. The vehicle of claim 7, wherein the controller is further configured to detect presence of the active beacon attached to the specific object within the receptacle when a difference in received signal strength between the first wireless signal and the third wireless signal is greater than a difference in received signal strength between the second wireless signal and the fourth wireless signal.

12. The vehicle of claim 1, wherein the second detector is located proximate to a tipping position of the load arm, and the first detector is located proximate to a lowest position of the load arm.

13. The vehicle of claim 1, wherein the tag comprises an identifying number, and the identifying number comprises a specific sequence indicating presence of a hazardous battery.

14. The vehicle of claim 6, wherein the active beacon periodically transmits wireless signals.

15. The vehicle of claim 6, wherein the specific object comprises a battery, and the active beacon receives electrical power from the battery.

16. The vehicle of claim 1, wherein
the load arm is configured to rotate through a sequence of positions;
the first detector and the second detector are configured measure received signal strengths of wireless signals received at each of the sequence of positions of the load arm;
and the controller is configured to:
multiply the received signal strength of each of the sequence of positions with a function of a corresponding angle of each of the sequence of positions to form a measure of correlation of a signal sequence and the sequence of positions; and
detect and report presence of the beacon when a magnitude of the measure of the correlation exceeds a correlation threshold for both the received signal strengths of the wireless signals received by the first detector and the second detector.

17. A method of detecting presence of a tag attached to a specific object within a receptacle received by a load arm of a vehicle, comprising:
receiving, by a first detector associated with the vehicle, a first wireless signal when a load arm of the vehicle is in a first position;
receiving, by a second detector associated with a vehicle, a second wireless signal when the load arm is in a second position; and
detecting, by a controller, presence of a tag attached to a specific object within the receptacle based on the received signal strengths of the first wireless signal and the second wireless signal.

18. The method of claim 17, wherein the tag comprises a passive tag, and wherein detecting the presence of the tag based on the received signal first wireless signal and the second wireless signal comprises:
transmitting, by the first detector, a first continuous powerup signal, thereby initiating backscatter communication with the tag that includes a request that the tag backscatter its unique identification code when the load arm is in the first position, wherein the first wireless signal includes a first backscatter signal from the tag;
transmitting, by the second detector, a second continuous powerup signal, thereby initiating backscatter communication with the tag that includes a request that the tag backscatter its unique identification code when the load arm is in the second position, wherein the second wireless signal includes a second backscatter signal from the tag.

19. The method of claim 17, further comprising:
receiving, by the first detector, a third wireless signal when the load arm is in the second position; and
receiving, by the second detector, a fourth wireless signal when the load arm is in the first position.

20. The method of claim 17, wherein the tag comprises an active beacon, and further comprising:
receiving, by the first detector, a third wireless signal when the load arm is in the second position;
receiving, by the second detector, a fourth wireless signal when the load arm is in the first position; and
detecting, by the controller, presence of the active beacon attached to the specific object within the receptacle when a change between the received signal strengths of the first wireless signal, the third wireless signal, and a change between the received signal strengths of the second wireless signal and the fourth wireless signal are greater than a preselected threshold.
